(19) United States
(12) Patent Application Publication
(10) Pub. No.: US 2024/0172037 A1
(43) Pub. Date: May 23, 2024

(54) XR DATA HANDLING ON WI-FI AND CELLULAR ACCESS WITH PDU SET

(71) Applicant: Cisco Technology, Inc., San Jose, CA (US)

(72) Inventors: Vimal Srivastava, Bangalore (IN); Sri Gundavelli, San Jose, CA (US)

(21) Appl. No.: 18/471,087

(22) Filed: Sep. 20, 2023

(30) Foreign Application Priority Data
Nov. 22, 2022 (IN) 202241066903

(51) Int. Cl. H04W 28/02

(52) U.S. Cl. CPC H04W 28/0268

(57) ABSTRACT

Disclosed herein are systems, methods, and computer-readable media for generating Access Traffic Steering, Switching and Splitting (ATSSS) rules specific to different frame types of a flow, providing the ATSSS rules to a user plane function (UPF) so that the UPF detects Quality of Service (QOS) flows based on the different frame types of the flow, and transporting the different frame types of the flow on different access standards based on the ATSSS rules.

### CROSS-REFERENCE TO RELATED APPLICATIONS

This application claims priority to U.S. provisional application number 202241066903 filed on Nov. 22, 2022, which is expressly incorporated by reference herein in its entirety.

### TECHNICAL FIELD

The subject matter of this disclosure relates in general to the field of computer networking, and more particularly, to traffic flows within a network.

### BACKGROUND

Fifth generation (5G) mobile and wireless networks will provide enhanced mobile broadband communications and are intended to deliver a wider range of services and applications as compared to all prior generation mobile and wireless networks. Compared to prior generations of mobile and wireless networks, the 5G architecture is service based, meaning that wherever suitable, architecture elements are defined as network functions that offer their services to other network functions via common framework interfaces. In order to support this wide range of services and network functions across an ever-growing base of user equipment (UE), 5G networks incorporate the network slicing concept utilized in previous generation architectures.

Current mobile and wireless communication systems have widely adopted a next-generation wireless communication system, 5G, that provides much higher data rates and lower latency. With the 5G evolution, access traffic steering, switching and splitting (ATSSS) policies between the user equipment (UE) and the 5G User Plane Function (UPF) allow the network to transport packets onto different access networks. The ATSSS policies provide treatment of the traffic at the flow level, such as through the use of Quality of service (Qos) mechanisms that work on a network to control traffic and ensure the performance of critical applications with limited network capacity. QoS, for example, enables organizations to adjust their overall network traffic by prioritizing specific high-performance applications. Common services for which it is required include internet protocol television (IPTV), online gaming, streaming media, videoconferencing, video on demand (VOD), and Voice over IP (VOIP). As far as the core network is concerned, the different types of frames within the packets does not matter.

However, with the advent of XR data (e.g., virtual, augmented, and/or mixed reality services), network traffic should receive treatment based on the content of the packet rather than merely at the flow level, so that some packet types are prioritized for certain access networks over others.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example 5G network environment for XR data flows, in accordance with an example embodiment;

FIG. 2 illustrates an example 5G network environment for multiple XR data flows based on frame type, in accordance with an example embodiment;

FIG. 3 illustrates a method for the creation and distribution of multiple XR data flows based on frame type, in accordance with an example embodiment;

FIG. 4 illustrates filters specified by 3GPP access or non-3GPP access for traffic identification in ATSSS rules;

FIG. 5 illustrates an example flow diagram for the creation and distribution of multiple XR data flows based on frame type, in accordance with an example embodiment; and

FIG. 6 shows an example of computing system, according to some aspects of the present disclosure.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Overview

The present disclosure is directed to techniques for treating network traffic based on the content of the packets rather than merely at the flow level, so that some packet types are prioritized for certain access networks over others. For example, embodiments of the disclosure relate to applying cost treatments based on a type of frame (e.g., a PDU set basis) rather than on a cost of the flow basis.

In one aspect, a method includes generating Access Traffic Steering, Switching and Splitting (ATSSS) rules specific to different frame types of a flow, providing the ATSSS rules to a user plane function (UPF) so that the UPF detects Quality of Service (QOS) flows based on the different frame types of the flow, and transporting the different frame types of the flow on different access standards based on the ATSSS rules.

In another aspect, the method may also include further include adding an attribute PDU-SET type, based on the attribute PDU-SET type, creating separate QoS flows for different frame types based on generating ATSSS rules specific to each of the attribute PDU-SET type, and providing the ATSSS rules to the UPF, where the UPF transports the different frame types of the flow on different access standards based on the ATSSS rules.

In another aspect, the method may also include where the PDU-SET type includes I frames, B frames, and P frames within the flow, and where the ATSSS rules specify transport of the I frames to 3rd Generation Partnership Project (3GPP) access, and the ATSSS rules specify transport of the B frames and the P frames to non-3GPP access.

In another aspect, the method may also include further include generating the ATSSS rules based on one or more policies associated with an attribute PDU-SET type and dependencies between different attribute PDU-SET type, and pushing the ATSSS rules into the network at the UPF, where the ATSSS rules provide a PDU set type filter for dividing the traffic into multiple transport types.

In another aspect, the method may also include where the PDU-SET type includes I frames, B frames, and P frames within the flow, and where the one or more policies are based on B frame and P frame dependencies on I frames within the flow.

In another aspect, the method may also include adding an attribute PDU-SET type to Policy and Charging Control (PCC) rules provided by a Policy Control Function (PCF), where the PCF sets the attribute PDU-SET type as a type of filter, and creating separate QoS flows corresponding to each attribute PDU-SET type and generating the ATSSS rules at a Session Management Function (SMF).

In another aspect, the method may also include sending, by an SMF to a user equipment (UE), the ATSSS rules to configure the UE to distribute traffic in accordance with the different access standards.

In another aspect, the method may also include creating separate QoS flows for a first frame type of a flow and a second frame type of the flow, and providing the separate QoS flows and the ATSSS rules to a UPF on N4 signaling so that UPF detects QoS flows based on the first frame type and the second frame type.

In another aspect, the method may also include generating the ATSSS rules based on a guaranteed bit rate (GBR), where a first frame type with a GBR over a threshold is filtered for 3GPP access, and a second frame type with the GBR below the threshold is filtered for non-3GPP access, and providing the ATSSS rules based on the GBR to the UPF for traffic distribution.

In one aspect, a computing apparatus includes a processor. The computing apparatus also includes a memory storing instructions that, when executed by the processor, configure the apparatus to generate ATSSS rules specific to different frame types of a flow, provide the ATSSS rules to a user plane function (UPF) so that the UPF detects Quality of Service (QOS) flows based on the different frame types of the flow, and transport the different frame types of the flow on different access standards based on the ATSSS rules.

In one aspect, a non-transitory computer-readable storage medium, the computer-readable storage medium includes instructions that when executed by a computer, cause the computer to generate ATSSS rules specific to different frame types of a flow, provide the ATSSS rules to a user plane function (UPF) so that the UPF detects Quality of Service (QOS) flows based on the different frame types of the flow, and transport the different frame types of the flow on different access standards based on the ATSSS rules.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for network traffic receiving treatment based on the content of the packet rather than merely at the flow level so that certain packet types are prioritized for specific access networks over others. For example, different type of cost treatment can be applied for different types of frame. Specifically, the ATSSS rules can apply cost treatment to network traffic on a PDU set basis, instead of merely on a cost of the flow basis.

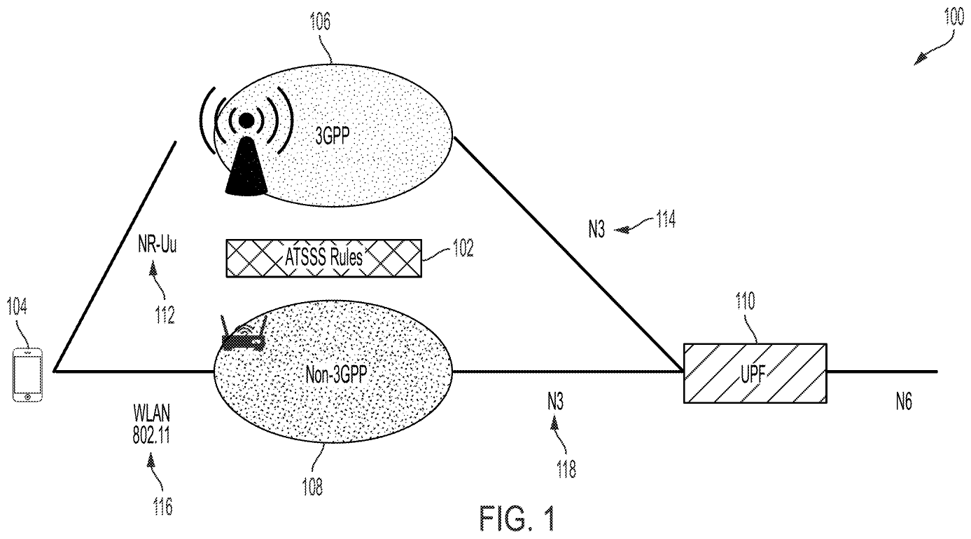

FIG. 1 illustrates an example 5G network environment for XR data flows, in accordance with an example embodiment. In some embodiments, as 5G network deployments advance, networks will need to provide for more capacity in the Radio Access Network (RAN) and more flexibility in network deployments, including support for private networks. In system 100, typically a user equipment (UE) 104 connects to a core network via 3rd Generation Partnership Project (3GPP) access 106, or non-3GPP access 108. In 3GPP Release 16 (R16) (TS 23.501), for example, the 5G User Plane Function (UPF) 110 can have defined Access traffic steering, switching and splitting (ATSSS) rules 102 that apply policies for flows between the UE 104 and the network across one or more of the 3GPP access 106 network and the non-3GPP access 108 network.

For example, when making a video session via 3GPP access 106, the packet path will begin from the UE 104, go to gNodeb in the 3GPP access 106 network (e.g., a physical entity, such as a tower, or it may be a virtual entity, such as a software defined radio (SDR)) via a 5G New Radio (NR-Uu) interface 112 connection, and then will go to UPF 110 via an N3 connection 114. The downlink packets will follow the same path in the reverse direction.

If the UE 104 wants to connect on the WiFi side, then UE 104 will connect through a type of Wi-Fi access point (e.g., non-3GPP access 108 via WLAN 802.11 116 connection), and then will go to UPF 110 via an N3 connection 118. In some embodiments, integration architectures can use interworking functions for non-3GPP access 108, such as Non-3GPP InterWorking Function (N3IWF) for untrusted access and Trusted Non-3GPP Gateway Function (TNGF) for trusted access, with Internet Protocol Security (IPsec) as the underlying transport.

Typically when a packet comes in the 3GPP access 106 or the Non-3GPP access 108 from some content or video service, all the packets within a flow are given the same kind of treatment based on the cost of the flow. As far as the core network is concerned, the content of the packets (e.g., for example, different types of frames within the packets) of the flow doesn't matter. However, certain characteristics related to content type do matter in practice: bit rates, certain costs, delivery and/or iteration rates are not the same and/or applicable to all packet types.

Extended reality (XR) media (e.g., virtual, augmented, and/or mixed reality) would benefit from traffic being given treatment based on the content of the packet. When treatment is consistent at the flow level, there is no visibility into the content of the packet. However, with XR data, even within the same flow, some packets require better treatment than others. What is needed is a system that prioritizes certain packet types over others.

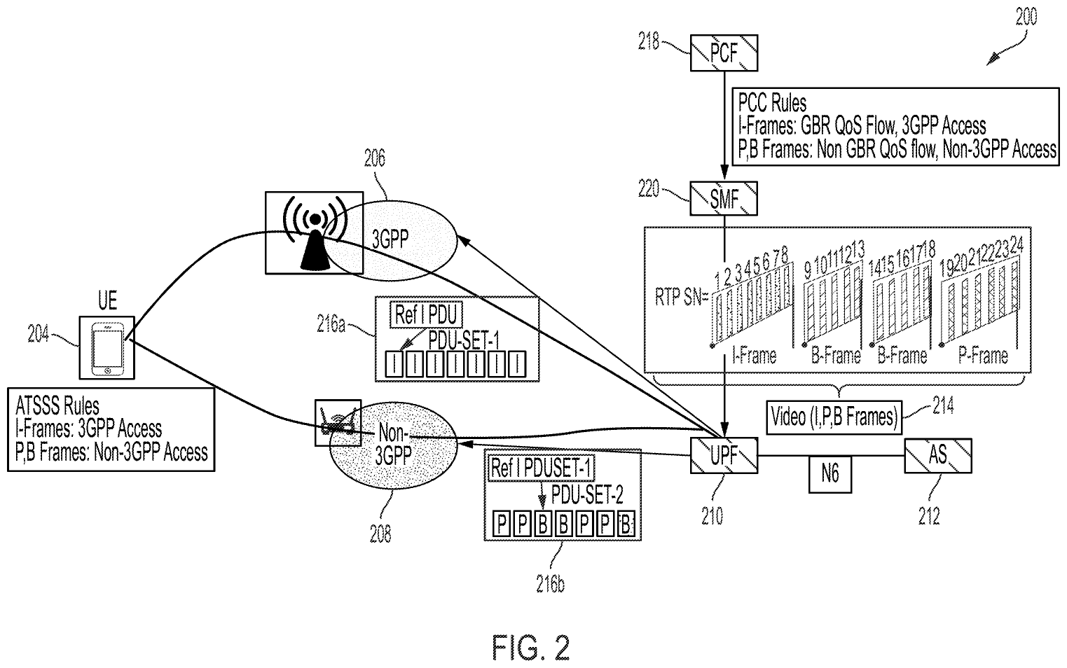

FIG. 2 illustrates an example 5G network environment for multiple XR data flows based on frame type, in accordance with an example embodiment. System 200 illustrates generating ATSSS rules specific to the content of packets within a flow. For example, the ATSSS rules can be based on routing certain frame types of a flow through a 3GPP access 206 or a non-3GPP access 208 between the UE 204 and application server (AS) 212.

The UPF 210 can include the ATSSS rules that route traffic through either the 3GPP access 206 and/or the non-3GPP access 208. In the example embodiment shown, ATSSS introduces the notion of a Multi Access PDU session, such as a PDU session for which the data traffic can be served over one or more concurrent accesses (e.g., 3GPP access, trusted non-3GPP access, and untrusted non-3GPP access). ATSSS allows the operator to configure ATSSS rules and push them to the device via 5GC. These rules dictate how the device should utilize these 3GPP 206 and non-3GPP access 208 networks it may have available, specifically with respect to sending uplink traffic. For downlink traffic, 5GC can provide rules to the UPF 210 which dictates which access network should be used for which traffic flow.

The ATSSS rules can be based on PDU-SET type. In system 200, AS 212 is sending video 214 to UE 204 that includes I frames, B frames, and P frames. In video 214, the I frames are the biggest, most important frames, as B frames and P frames only carry information about the differences from the I frames. This means that if the I frame is lost within video 214, the B frames and P frames are useless.

To create ATSSS rules based on frame types, the ATSSS rules can be modified by adding an attribute PDU-SET type. For example, the PDU-SET type can include an I frame PDU-SET type, B frame PDU-SET type, and P frame PDU-SET type within each flow. Based on the attribute PDU-SET type, the UPF 210 can create separate QOS flows for the different frame types based on the modified ATSSS rules specific to each of the attribute PDU-SET types. For example, the ATSSS rules can specify transport of the I frames to 3GPP access 206, and the ATSSS rules can specify transport of the B frames and the P frames to non-3GPP access 208. In this example, PDU-SET-1 216a is sent for 3GPP access 206, which includes I frames; and PDU-SET-2 216b is sent for non-3GPP access 208, which includes both P frames and B frames. Therefore, when the

[symbol]

In some embodiments, the attribute PDU-SET type can be added to the ATSSS rules at the Policy and Charging Control (PCC) rules provided by a Policy Control Function (PCF) 218. The PCF 218 can set the attribute PDU-SET type as a type of filter, for example. Based on the PDU-SET type filter, a Session Management Function (SMF) 220 can create separate QoS flows corresponding to each attribute PDU-SET type and generate the ATSSS rules that are sent to the UPF 210. In some embodiments, the PCF 218 can generate the modified ATSSS rules based on one or more policies associated with an attribute PDU-SET type and dependencies between different attribute PDU-SET type. For example, if the PDU-SET type comprises I frames, B frames, and P frames within the flow, then one or more policies can be based on B frame and P frame dependencies on I frames within the flow (e.g., because of the B and P frame dependencies on I frame content, the PCF 218 can cause the SMF 220 to generate QoS flows that prioritize I frames over B and P frames).

The SMF 220 can provide the ATSSS rules to the UPF 210 so that the UPF 210 detects Quality of Service (QOS) flows based on the different frame types of the flow. For example, based on the ATSSS rules, the UPF 210 can transport different frame types of each packet within the flow on different access standards (e.g., 3GPP access 206 vs non-3GPP access 208). This can be, for example, the ATSSS rules being pushed into the network at the UPF 210, where the ATSSS rules provide a PDU set type filter for dividing the traffic into the multiple transport types.

Additionally and/or alternatively, the SMF 220 can send the ATSSS rules to the UE 204. Based on the ATSSS rules, the UE 204 can distribute traffic through 3GPP access 206 and/or non-3GPP access 208 based on frame type (e.g., based on the attribute PDU-SET type, creating separate QoS flows for the different frame types).

The example embodiment shown is one such example where ATSSS rules can be modified to take into account the content of a packet in order to make routing decisions using 3GPP access 206 or non-3GPP access 208. QoS flows can be created for any frame types of a flow, such that the separate QoS flows and the ATSSS rules can be provided to UPF 210, so that the UPF 210 can detect QoS flows based on, say, a first frame type and a second frame type.

Additionally and/or alternatively, the ATSSS rules can be generated and/or modified based on a guaranteed bit rate (GBR), where a first frame type with a GBR over a threshold is filtered for 3GPP access 206, and a second frame type with the GBR below the threshold is filtered for non-3GPP access 208. Similar to the examples above, the ATSSS rules based on the GBR can be provided to the UPF 210 (and/or UE 204) for traffic distribution.

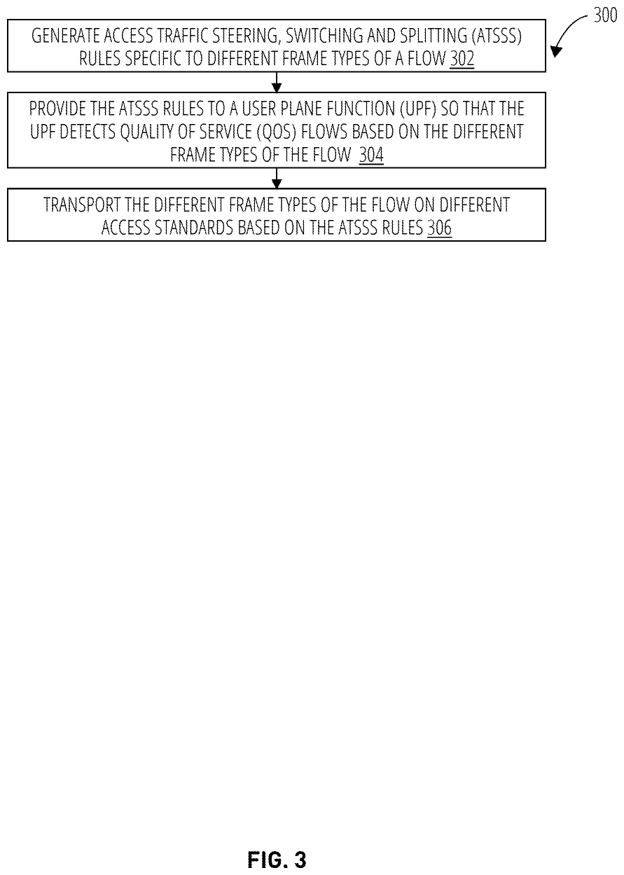

FIG. 3 illustrates a method for the creation and distribution of multiple XR data flows based on frame type, in accordance with an example embodiment.

In block 302, routine 300 generates ATSSS rules specific to different frame types of a flow. For example, the ATSSS rules can contain traffic descriptors (e.g., filters to identify flows) and rules about on which access it would be transported. For a video flow, typically a GBR QOS flow can be created and all the video frames (I, P. B) are part of the same QoS flow, and the same QoS policies are applied to all frame-types (PDU-SETs). The techniques herein disclose ATSSS rules that apply PDU SET differentiated QoS policies, taking dependencies between the PDU SET types into account.

For example, in the context of ATSSS rules determining whether to send packets to 3GPP access or non-3GPP access based on PDU-SETs, given that different PDU-SETS carry different frames types of varied importance, the ATSSS rules can be enhanced for bringing the needed forwarding treatment. For example, the traffic descriptor can be enhanced to distribute traffic across different access systems based on PDU-SETs/frame type awareness. If this awareness is implemented, it is possible to split XR data across 3GPP and non-3GPP access systems. Furthermore, it is possible to provide frame-aware QoS flows. For example, GBR treatment for I-frames and non-GBR treatment for P and B frames.

Therefore, in the context of generating ATSSS rules specific to different frame types of a flow, an attribute PDU-SET type can be added to the ATSSS rules that distinguishes between different types of packet content. For example, the PDU-SET type can include I frames, B frames, and P frames within the flow, whereas the corresponding ATSSS rules can specify transport of the I frames to 3GPP access, and the ATSSS rules can specify transport of the B frames and the P frames to non-3GPP access. Therefore, based on the attribute PDU-SET type, separate QoS flows for different frame types can be created based on generating ATSSS rules specific to each of the attribute PDU-SET type.

In some embodiments, the attribute PDU-SET type can be added to the Policy and Charging Control (PCC) rules provided by a Policy Control Function (PCF), where the PCF sets the attribute PDU-SET type as a type of filter. Separate QoS flows corresponding to each attribute PDU-SET type can be created and the ATSSS rules can be generated at a Session Management Function (SMF). For example, in the PCCRules provided by PCF, the addition of a new attribute PDU-SET Type, which can, for example, take values based on frame types, I, P or B. The SMF can then create separate QoS Flows for different frame types and also generate ATSSS Rules specific to PDU-SET (frame type). In some embodiments, the SMF will also provide this information to the UPF on N4 signaling so that the UPF can detect QoS flows based on frame types and transport different types of frames on different access's based on policies.

For example, the policies on which the ATSSS rules are based can be associated with an attribute PDU-SET type and dependencies between different attribute PDU-SET types. As an example, the PDU-SET type can include I frames, B frames, and P frames within the flow, and one or more policies can be based on B frame and P frame dependencies on I frames within the flow. In this case, I frames are the largest frames with complete XR data, while B and P frames only carry information about differences between the content of the I frame.

In block 304, routine 300 provides the ATSSS rules to the UPF so that the UPF detects QoS flows based on the different frame types of the flow. For example, the ATSSS rules can be pushed into the network at the UPF, where the ATSSS rules provide a PDU set type filter for dividing the traffic into its multiple transport types.

Additionally and/or alternatively, the ATSSS rules can be sent by the SMF to the UE in order to configure the UE to distribute traffic in accordance with the different access standards. For example, in some embodiments the SMF sends the ATSSS Rules to UE so that the UE, while sending UL traffic, can distribute the traffic to different access networks. This can include introducing a PDU-Set type filter, which can have values (e.g. Frame Type) or some other way to classify the PDU-Sets. For GBR flow distributions across different access types, the ATSSS rules can specify that I-frame types can be on 3GPP access and P/B frame can be on non-3GPP access.

In block 306, routine 300 transports the different frame types of the flow on different access standards based on the ATSSS rules. For example, based on the attribute PDU-SET type, separate QoS flows are created for different frame types: a first QoS flow for I frames (destined for 3GPP access), and another QoS flow for P and B frame types (destined for non-3GPP access).

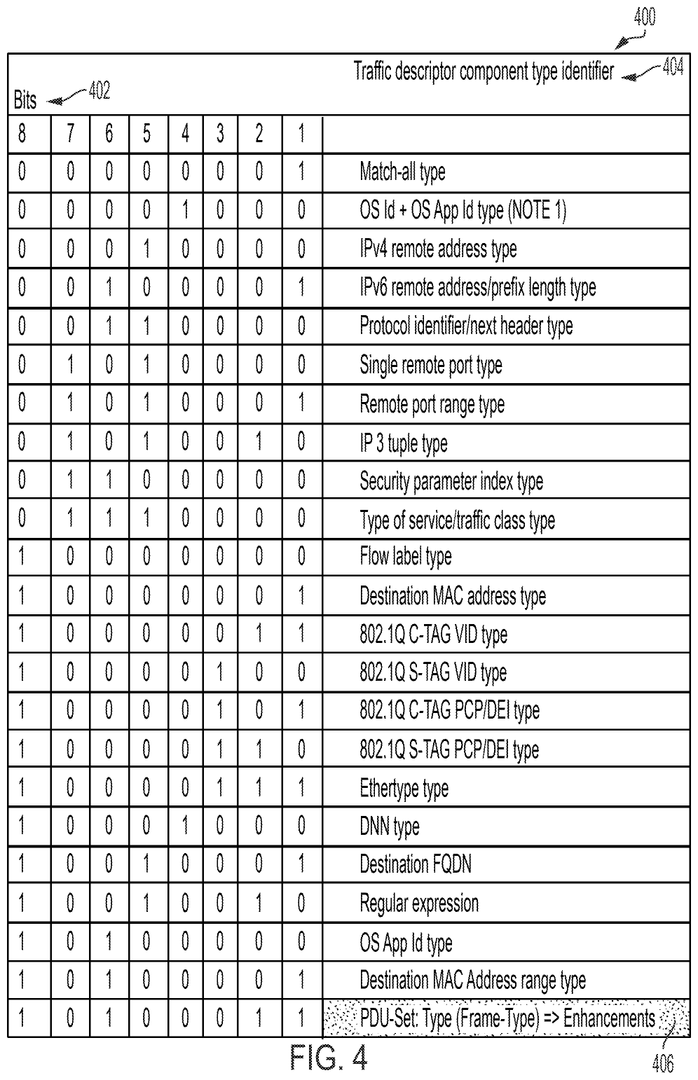

FIG. 4 illustrates filters specified by 3GPP access or non-3GPP access for traffic identification in ATSSS rules. Table 400 shows bits 402 corresponding to traffic descriptors 404. The traffic descriptors 404 act as filters that are specified by 3GPP for traffic identification in the ATSSS rules. In the example embodiment, the traffic descriptor 404 field is, as defined in table 400 in 3GPP TS 24.526, of variable size and contains a variable number (e.g., at least one) of traffic descriptor components. Each traffic descriptor component can be encoded as a sequence of one octet traffic descriptor component type identifier and a traffic descriptor component value field. The traffic descriptor component type identifier can be transmitted first. Traffic descriptor 406 corresponds to PDU-SET type (e.g., which can be used as enhancements to the ATSSS rules).

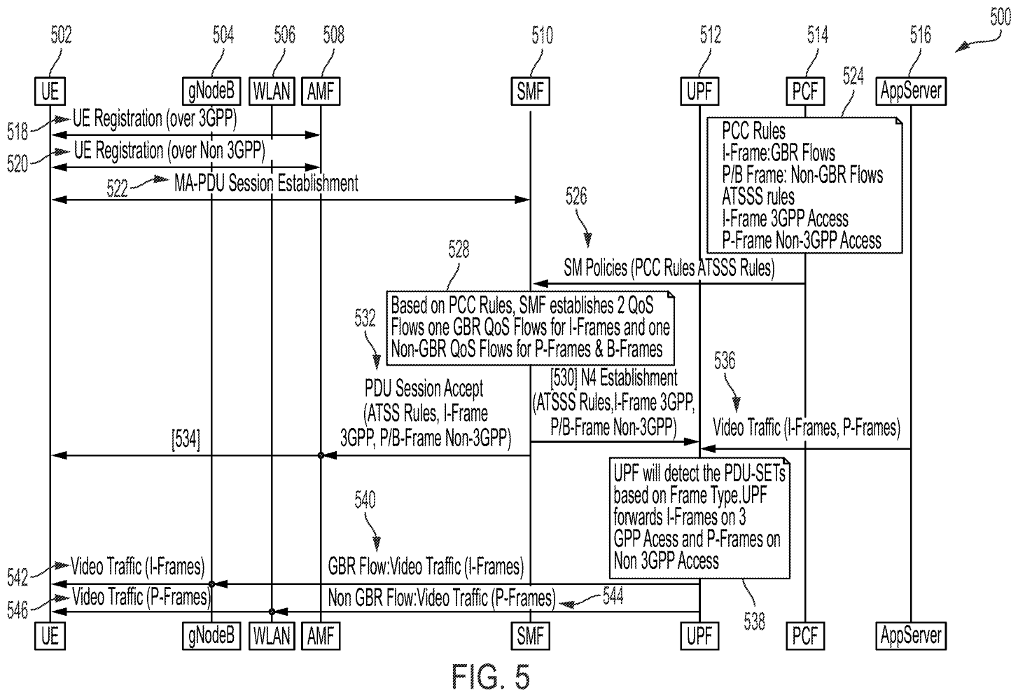

FIG. 5 illustrates an example flow diagram for the creation and distribution of multiple XR data flows based on frame type, in accordance with an example embodiment. System 500 brings frame awareness in the creation of the QoS Flows so that it is possible to send certain types of frames (e.g. I frames) over one access (e.g. 3GPP access) and other types of frames (e.g. P/B frames) over another access (e.g. Non-3GPP access). Given that I frames are critical whereas P/B frames are not as critical, by bringing frame awareness it is also possible to provide GBR treatment only to the I frames, whereas P/B frames can be given non-GBR treatment.

System 500 includes a UE 502, gNodeB 504 (e.g., a 5G base station), WLAN 506, Access and Mobility Management Function (AMF) 508, SMF 510, UPF 512, PCF 514, and AS 516 in communication with each other. In step 518, UE Registration is done over 3GPP access between the UE 502 and the AMF 508. UE Registration is also done over non-3GPP access between the UE 502 and the AMF 508 at step 520. After the UE Registration is done over 3GPP and non-3GPP, at step 522 a Multi-Access PDU session (MA-PDU) is established between the UE 502 and the SMF 510.

The PCF 514 has PCC Rules 524 that specify policies, such as I frames should receive GBR flow treatment and P/B frames should receive non-GBR flow treatment. The PCF 514 can generate ATSSS rules based on those policies to assign I frames to 3GPP access, and P (and B) frames for non-3GPP access. At step 526, the session management policies (e.g., PCC rules, ATSSS rules) are sent by the PCF 514 to the SMF 510. Based on the PCC rules and/or ATSSS rules, the SMF establishes corresponding QoS flows at step 528. For example, the SMF 510 can establish two QoS flows: a first GBR QoS flow for I frames, and a second non-GBR QoS flow for P frames and B frames.

The SMF 510 can then either send the ATSSS rules to the UPF 512, the UE 502, and/or both. If the SMF 510 sends to the UPF 512, the ATSSS rules (e.g., I frames for 3GPP access, P/B frames for non-3GPP access) are sent to the UPF 512 via N4 establishment. If the SMF 510 sends the ATSSS rules to the UE 502, the SMF 510 sends the ATSSS rules (e.g., I frames for 3GPP access, P/B frames for non-3GPP access) to the AMF 508 via a PDU Session Accept, and then the AMF 508 sends the ATSSS rules to the UE 502.

In this way, once the AS 516 sends video traffic in step 536 including both I frames and P frames, the UPF 512 will detect the PDU-SET types (I and P) based on frame type in step 538. The UPF 512 then forwards the I frames and P frames accordingly. For the I frames, the UPF 512 sends the GBR flow (e.g., I frames within the video traffic) to gNodeB 504 for 3GPP access in step 540, and then forwards the I frames within the video traffic to the UE 502 in step 542. For the P frames, the UPF 512 sends the non-GBR flow (e.g., P frames within the video traffic, although other embodiments also include B frames) to WLAN 506 for non-3GPP access in step 544, and then forwards the P frames within the video traffic to the UE 502 in step 546.

Therefore, frame awareness is brought in creation of the QoS Flows so that it is possible to send certain type of frames (e.g. I frames) over one access (e.g. 3GPP) and other types of frames (e.g. P/B frames) over other access (e.g. Non 3GPP). Given that I frames are important whereas P/B frames are not so important (e.g., by having dependencies on I frame data), by bringing frame awareness it is also possible to provide GBR treatment only to I frame packets and whereas P/B frame packets can be given non-GBR treatment.

The example embodiment shown is one such example where ATSSS rules can be modified to take into account the content of a packet in order to make routing decisions using 3GPP access or non-3GPP access. QoS flows can be created for any frame types of a flow, such that the separate QoS flows and the ATSSS rules can be provided to UPF 210, so that the UPF 210 can detect QoS flows based on, say, a first frame type and a second frame type. For example, there are many different ways of classifying packets beyond just I. P. and B frames. Audio from an important speaker in a conference can be a first frame type, while less important participants can be a second type of frame. Regardless of the distinction between packet types, the ATSSS rules can use the different packet types as a method of dividing the traffic between two transports (e.g., 3GPP access vs non-3GPP access).

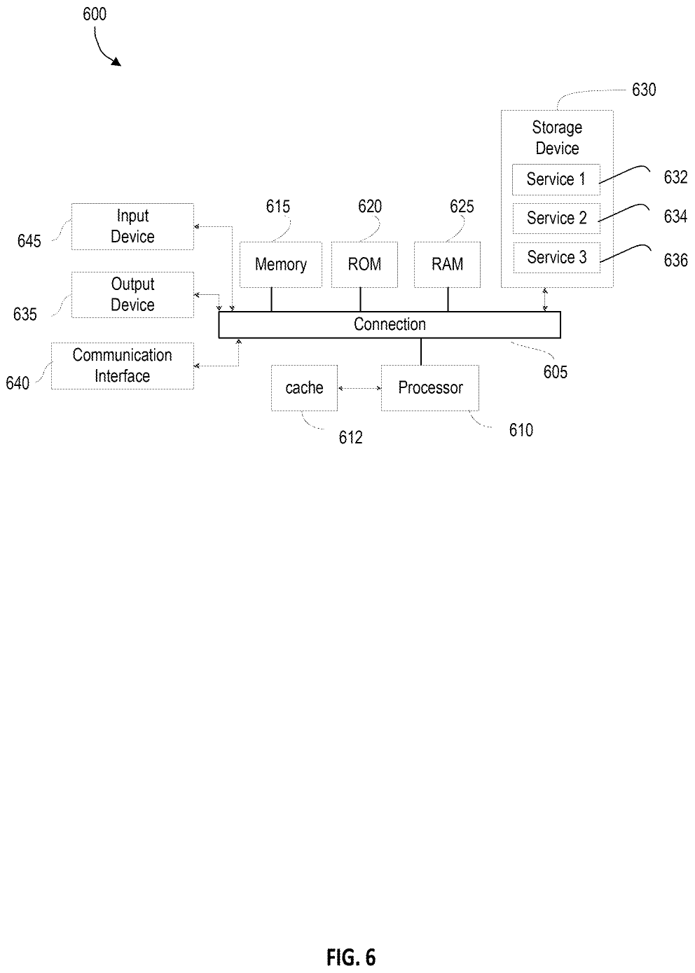

FIG. 6 shows an example of computing system 600, which can be for example any computing device or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments computing system 600 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read only memory (ROM) 620 and random access memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
generating Access Traffic Steering, Switching and Splitting (ATSSS) rules specific to different frame types of a flow;
providing the ATSSS rules to a user plane function (UPF) so that the UPF detects Quality of Service (QOS) flows based on the different frame types of the flow; and
transporting the different frame types of the flow on different access standards based on the ATSSS rules.

2. The method of claim 1, further comprising:
adding an attribute PDU-SET type;
based on the attribute PDU-SET type, creating separate QoS flows for different frame types based on generating ATSSS rules specific to each of the attribute PDU-SET type; and
providing the ATSSS rules to the UPF, wherein the UPF transports the different frame types of the flow on different access standards based on the ATSSS rules.

3. The method of claim 2, wherein the attribute PDU-SET type comprises I frames, B frames, and P frames within the flow, and wherein the ATSSS rules specify transport of the I frames to 3rd Generation Partnership Project (3GPP) access, and the ATSSS rules specify transport of the B frames and the P frames to non-3GPP access.

4. The method of claim 1, further comprising:
generating the ATSSS rules based on one or more policies associated with an attribute PDU-SET type and dependencies between different attribute PDU-SET types; and
pushing the ATSSS rules into a network at the UPF, wherein the ATSSS rules provide a PDU set type filter for dividing traffic into multiple transport types.

5. The method of claim 4, wherein the PDU-SET type comprises I frames, B frames, and P frames within the flow, and wherein the one or more policies are based on B frame and P frame dependencies on the I frames within the flow.

6. The method of claim 1, the method further comprising:
adding an attribute PDU-SET type to Policy and Charging Control (PCC) rules provided by a Policy Control Function (PCF), wherein the PCF sets the attribute PDU-SET type as a type of filter; and
creating separate QoS flows corresponding to each attribute PDU-SET type and generating the ATSSS rules at a Session Management Function (SMF).

7. The method of claim 1, the method further comprising:
sending, by an SMF to a user equipment (UE), the ATSSS rules to configure the UE to distribute traffic in accordance with the different access standards.

8. The method of claim 1, the method further comprising:
creating separate QoS flows for a first frame type of a flow and a second frame type of the flow; and
providing the separate QoS flows and the ATSSS rules to the UPF on N4 signaling so that the UPF detects QoS flows based on the first frame type and the second frame type.

9. The method of claim 1, the method further comprising:
generating the ATSSS rules based on a guaranteed bit rate (GBR), wherein a first frame type with the GBR over a threshold is filtered for 3GPP access, and a second frame type with the GBR below the threshold is filtered for non-3GPP access; and
providing the ATSSS rules based on the GBR to the UPF for traffic distribution.

10. A computing apparatus comprising:
a processor; and
a memory storing instructions that, when executed by the processor, configure the apparatus to:
generate Access Traffic Steering, Switching and Splitting (ATSSS) rules specific to different frame types of a flow;
provide the ATSSS rules to a user plane function (UPF) so that the UPF detects Quality of Service (QOS) flows based on the different frame types of the flow; and
transport the different frame types of the flow on different access standards based on the ATSSS rules.

11. The computing apparatus of claim 10, wherein the instructions further configure the computing apparatus to:
add an attribute PDU-SET type;
based on the attribute PDU-SET type, create separate QoS flows for different frame types based on generating ATSSS rules specific to each of the attribute PDU-SET type; and
provide the ATSSS rules to the UPF, wherein the UPF transports the different frame types of the flow on different access standards based on the ATSSS rules.

12. The computing apparatus of claim 11, wherein the attribute PDU-SET type comprises I frames, B frames, and P frames within the flow, and wherein the ATSSS rules specify transport of the I frames to 3rd Generation Partnership Project (3GPP) access, and the ATSSS rules specify transport of the B frames and the P frames to non-3GPP access.

13. The computing apparatus of claim 10, wherein the instructions further configure the computing apparatus to:
generate the ATSSS rules based on one or more policies associated with an attribute PDU-SET type and dependencies between different attribute PDU-SET type; and
push the ATSSS rules into a network at the UPF, wherein the ATSSS rules provide a PDU set type filter for dividing traffic into multiple transport types.

14. The computing apparatus of claim 13, wherein the attribute PDU-SET type comprises I frames, B frames, and P frames within the flow, and wherein the one or more policies are based on B frame and P frame dependencies on I frames within the flow.

15. A non-transitory computer-readable storage medium, the non-transitory computer-readable computer-readable storage medium including instructions that when executed by a computer, cause the computer to:
generate Access Traffic Steering, Switching and Splitting (ATSSS) rules specific to different frame types of a flow;
provide the ATSSS rules to a user plane function (UPF) so that the UPF detects Quality of Service (QOS) flows based on the different frame types of the flow; and
transport the different frame types of the flow on different access standards based on the ATSSS rules.

16. The non-transitory computer-readable storage medium of claim 15, wherein the instructions further:
add an attribute PDU-SET type;
based on the attribute PDU-SET type, create separate QoS flows for different frame types based on generating ATSSS rules specific to each of the attribute PDU-SET type; and
provide the ATSSS rules to the UPF, wherein the UPF transports the different frame types of the flow on different access standards based on the ATSSS rules.

17. The non-transitory computer-readable storage medium of claim 16, wherein the attribute PDU-SET type comprises I frames, B frames, and P frames within the flow, and wherein the ATSSS rules specify transport of the I frames to 3rd Generation Partnership Project (3GPP) access, and the ATSSS rules specify transport of the B frames and the P frames to non-3GPP access.

18. The non-transitory computer-readable storage medium of claim 15, wherein the instructions further:
generate the ATSSS rules based on one or more policies associated with an attribute PDU-SET type and dependencies between different attribute PDU-SET type; and
push the ATSSS rules into a network at the UPF, wherein the ATSSS rules provide a PDU set type filter for dividing traffic into multiple transport types.

19. The non-transitory computer-readable storage medium of claim 18, wherein the PDU-SET type comprises I frames, B frames, and P frames within the flow, and wherein the one or more policies are based on B frame and P frame dependencies on the I frames within the flow.

20. The non-transitory computer-readable storage medium of claim 15, wherein the instructions further:
add an attribute PDU-SET type to Policy and Charging Control (PCC) rules provided by a Policy Control Function (PCF), wherein the PCF sets the attribute PDU-SET type as a type of filter; and
create separate QoS flows corresponding to each attribute PDU-SET type and generating the ATSSS rules at a Session Management Function (SMF).
